(19) United States
(12) Patent Application Publication
(10) Pub. No.: US 2006/0077671 A1
(43) Pub. Date: Apr. 13, 2006

(54) Dental illumination device

(75) Inventor: Yehonatan Edelman, Mitzpe Netofa (IL)

Correspondence Address: DR. MARK FRIEDMAN LTD.;C/O BILL POLKINGHORN, DISCOVERY DISPATCH, 9003 FLORIN WAY, UPPER MARLBORO, MD, 20772, US

(73) Assignee: Dr. Edelman Dental Clinics Ltd.

(21) Appl. No.: 10/962,532

(22) Filed: Oct. 13, 2004

(51) Int. Cl. F21V 21/08

(52) U.S. Cl. 362/396; 362/804; 362/249

(57) ABSTRACT

A medical illumination device for illuminating a desired region of a patient, the device being for use by a medical practitioner with a medical instrument, the device including: a housing; at least one light source disposed in the housing; an attachment configuration configured for reversibly attaching the housing to the medical instrument; a reflecting element configured for directing light emitted by the at least one light source on to the desired region of the patient; and a connecting member mechanically connecting the reflecting element and the housing such that, the reflecting element is rotatable in order to selectively direct light emitted by the at least one light source on to the desired region of the patient.

### FIELD AND BACKGROUND OF THE INVENTION

The present invention relates to a medical illumination device and, in particular, it concerns a compact self-powered dental illumination device.

By way of introduction, adequate lighting is essential for both minor and major surgical procedures as well as for routine checking procedures performed by a dentist or physician. Light provided from a source outside of the body is often blocked by the surgeon or the medical instruments. Additionally, an external light source does not provide enough light at the surgical field. Therefore, it is desirable to have a light source that provides light directly in the body cavity.

Of relevance to the present invention is U.S. Pat. No. 2,539,828 to Goldis, et al. which teaches a light attachment for a dental drill. The device of Goldis, et al. has many shortcomings. First, the device is not self-powered and therefore the power cord interferes with use of the dental instrument. Second, the light cannot be directed easily. Third, the device includes sharp edges which could damage tissue. Fourth, the device is complicated, probably expensive to construct as well as being difficult, if not impossible, to sterilize.

Also of relevance to the present invention is U.S. Pat. No. 6,607,384 to Nakanishi. Nakanishi teaches a lighting device which is permanently installed in a medical instrument, such as a dental drill. The device of Nakanishi has many shortcomings. First, the device cannot be moved from one medical instrument to another. Second, the device is generally expensive to install. There are many similar devices to that taught by Nakanishi which use fiber optic cables for lighting the oral cavity. The optic fibers are typically installed in the dental instrument and are therefore not transferable between the instruments. Additionally, installation of lighting devices in the dental instruments increases the maintenance costs of the instruments.

Also of relevance to the present invention is U.S. Pat. No. 6,428,180 to Karram, et al. which teaches a self-powered compact lighting unit which is attachable to a variety of medical instruments. Karram, et al. has many shortcomings. First, the light cannot be directed easily. Second, the device cannot be sterilized in an autoclave or similar device. Third, the device has sharp edges which could damage the tissue. Fourth, the light is unprotected by a cover and therefore the glare from the light interferes with the surgeon's operations. Fifth, the light from the light source diverges and therefore the light propagates to regions where lighting is not needed. Additionally, not enough light reaches the target tissue.

There are also other dental lighting systems, for example, a halogen based lighting system for use with a disposable dental mirror. The aforementioned system has a number of shortcomings. First, the light intensity at the surgical field is very poor. Second, the light source is not transferable to different instruments. Third, the system is very expensive, as the dental mirror needs to be replaced after each use. Another system includes a light source worn on the head of the dental surgeon. The light produced by this system is often blocked by the hands of the surgeon and instruments being used. The aforementioned system is also very expensive apart from the obvious drawbacks of having to wear a lighting system that is connected via a cable to a power supply.

There is therefore a need for a compact, low cost, self-powered dental illumination device for easy attachment to, and detachment from, a variety of dental instruments, the device being able to concentrate and direct the light as well as protecting the dental surgeon from glare as well as not causing damage to the mouth tissue.

### SUMMARY OF THE INVENTION

The present invention is a medical illumination device and method of operation thereof.

According to the teachings of the present invention there is provided, a medical illumination device for illuminating a desired region of a patient, the device being for use by a medical practitioner with a medical instrument, the device comprising: (a) a housing; (b) at least one light source disposed in the housing; (c) an attachment configuration configured for reversibly attaching the housing to the medical instrument; (d) a reflecting element configured for directing light emitted by the at least one light source on to the desired region of the patient; and (e) a connecting member mechanically connecting the reflecting element and the housing such that, the reflecting element is rotatable in order to selectively direct light emitted by the at least one light source on to the desired region of the patient.

According to a further feature of the present invention, when the housing and the reflecting element are mechanically connected, the housing and the reflecting element fit into a cylinder having a diameter of 8 mm and a length of 5 cm.

According to a further feature of the present invention, at least one of the reflecting element and the connecting member are configured for blocking direct vision by the medical practitioner of the at least one light source.

According to a further feature of the present invention, the connecting member includes a locking mechanism configured for reversibly locking a position of the reflecting element.

According to a further feature of the present invention, the reflecting element is configured as a curved reflecting surface.

According to a further feature of the present invention, the reflecting element includes a substantially cylindrical reflecting surface, the substantially cylindrical reflecting surface being disposed around the at least one light source.

According to a further feature of the present invention, the reflecting element is configured to concentrate the light produced by the at least one light source.

According to a further feature of the present invention, the housing, the attachment configuration and the reflecting element are configured to withstand sterilization.

According to a further feature of the present invention, the attachment configuration includes a first clamping member and a second clamping member, the first clamping member being permanently mechanically connected to the second clamping member, the first clamping member including a restoring element for restoring a shape of the first clamping member after expansion, the second clamping member including a restoring element for restoring a shape of the second clamping member after expansion, the first clamping member being configured for being reversibly attached to the medical instrument, the second clamping member being configured for being reversibly attached to the housing.

According to a further feature of the present invention, the attachment configuration includes a set of interchangeable attachment elements for reversibly attaching the housing to a plurality of different size medical instruments, each of the interchangeable attachment elements having a uniquely sized clamping member configured for being reversibly attached to one of the medical instruments.

According to a further feature of the present invention: (a) the uniquely sized clamping member includes a restoring element for restoring a shape of the uniquely sized clamping member after expansion; (b) each of the interchangeable attachment elements also includes a second clamping member including a restoring element for restoring a shape of the second clamping member after expansion; and (c) the second clamping member being configured for being reversibly attached to the housing.

According to the teachings of the present invention there is also provided a self-powered medical illumination device for illuminating a desired region of a patient, the device being for use by a medical practitioner with a medical instrument, the device comprising: (a) a housing; (b) at least one light source disposed in the housing; (c) a power source disposed in the housing, the power source configured for powering the at least one light source; (d) an attachment configuration configured for reversibly attaching the housing to the medical instrument; and (e) a reflecting element configured for directing light emitted by the at least one light source on to the desired region of the patient.

According to a further feature of the present invention, the reflecting element is configured as a curved reflecting surface.

According to a further feature of the present invention, the reflecting element includes a substantially cylindrical reflecting surface, the substantially cylindrical reflecting surface being disposed around the at least one light source.

According to a further feature of the present invention, there is also provided a connecting member mechanically connecting the reflecting element and the housing such that, the reflecting element is rotatable in order to selectively direct light emitted by the at least one light source on to the desired region of the patient.

According to a further feature of the present invention, the housing, the attachment configuration and the reflecting element are configured to withstand sterilization.

According to the teachings of the present invention there is also provided a medical illumination device for use by a medical practitioner with a medical instrument, the device comprising: (a) a housing; (b) at least one light source disposed in the housing; and (c) an attachment configuration configured for reversibly attaching the housing to the medical instrument, the attachment configuration including a first clamping member and a second clamping member, the first clamping member being permanently mechanically connected to the second clamping member, the first clamping member including a restoring element for restoring a shape of the first clamping member after expansion, the second clamping member including a restoring element for restoring a shape of the second clamping member after expansion, the first clamping member being configured for being reversibly attached to the medical instrument, the second clamping member being configured for being reversibly attached to the housing.

According to a further feature of the present invention, there is also provided a power source disposed in the housing.

According to the teachings of the present invention there is also provided a medical illumination device for use by a medical practitioner with a plurality of different size medical instruments, the device comprising: (a) a housing; (b) at least one light source disposed in the housing; and (c) an attachment configuration including a set of interchangeable attachment elements for reversibly attaching the housing to the different size medical instruments, each of the interchangeable attachment elements having a uniquely sized clamping member configured for being reversibly attached to one of the medical instruments.

According to a further feature of the present invention, there is also provided a power source disposed in the housing.

According to a further feature of the present invention: (a) the uniquely sized clamping member includes a restoring element for restoring a shape of the uniquely sized clamping member after expansion; (b) each of the interchangeable attachment elements also includes a second clamping member including a restoring element for restoring a shape of the second clamping member after expansion; and (c) the second clamping member being configured for being reversibly attached to the housing.

### BRIEF DESCRIPTION OF THE DRAWINGS

The invention is herein described, by way of example only, with reference to the accompanying drawings, wherein:

FIG. 1 is an isometric view of a medical illumination device that is constructed and operable in accordance with a preferred embodiment of the invention;

FIG. 2 is a plan view of the device of FIG. 1;

FIG. 3 is a plan view of the device of FIG. 1 after being extended;

FIG. 4 is view of the anterior end of the device of FIG. 1;

FIG. 5 is a cross-sectional view through line A-A of FIG. 2;

FIG. 6 is a cross-sectional view through line B-B of FIG. 3;

FIG. 7 is a cross-sectional view through line C-C of FIG. 2;

FIG. 8 is an enlarged cross-sectional view of the posterior section of the device through line A-A of FIG. 2;

FIG. 9a is a side view of a first interchangeable attachment element for use with the device of FIG. 1;

FIG. 9b is a side view of a second interchangeable attachment element for use with the device of FIG. 1; and

FIG. 9c is a side view of a third interchangeable attachment element for use with the device of FIG. 1.

### DESCRIPTION OF THE PREFERRED EMBODIMENTS

The present invention is a medical illumination device and method of operation thereof.

The principles and operation of a medical illumination device according to the present invention may be better understood with reference to the drawings and the accompanying description.

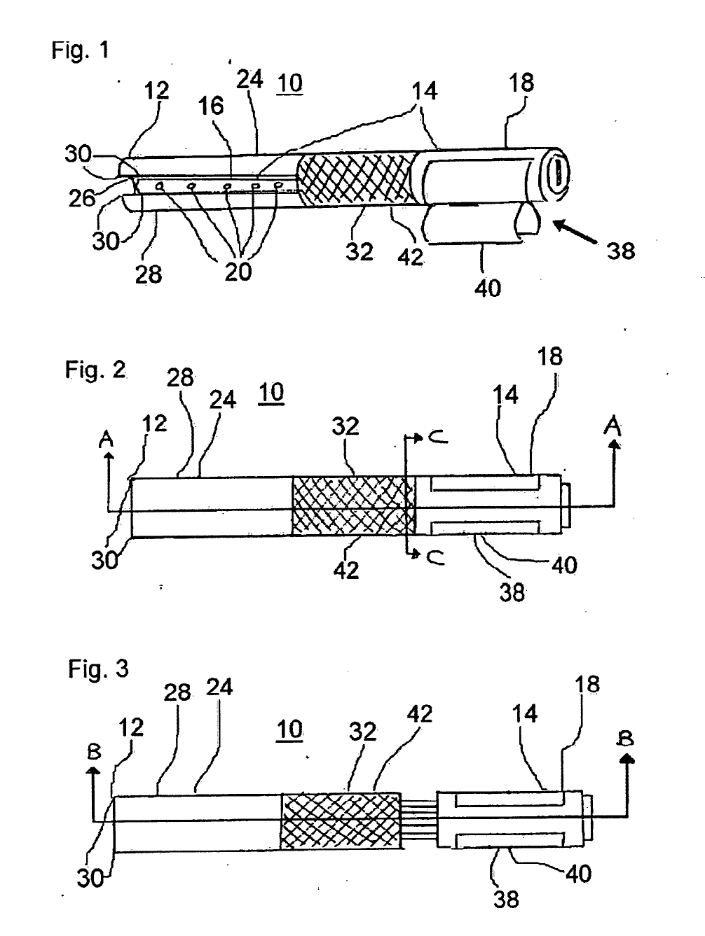

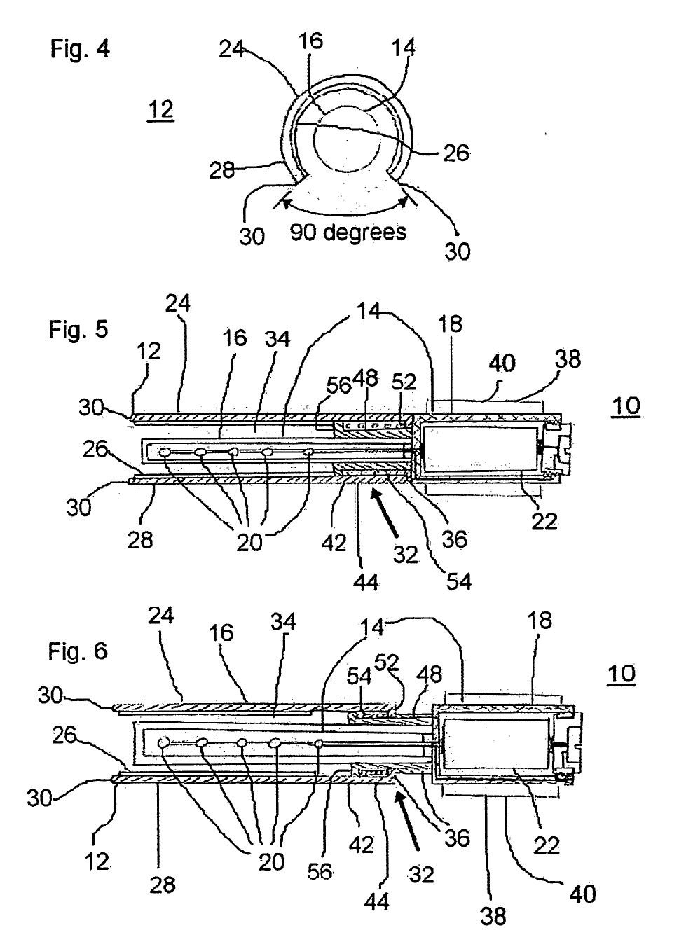

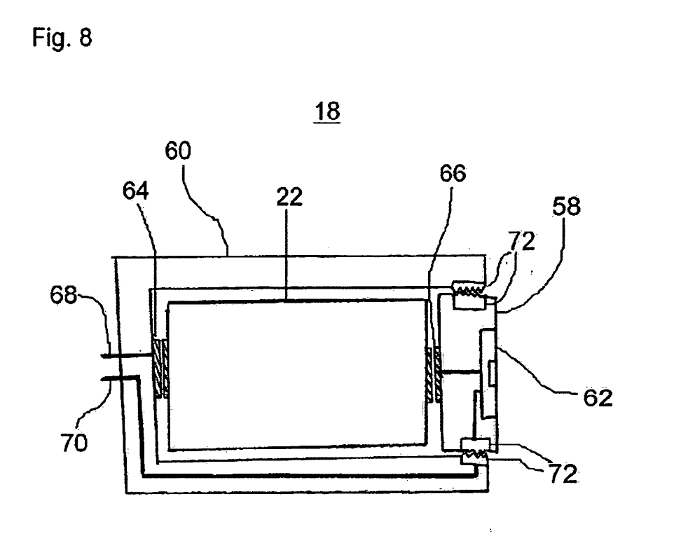

Reference is now made to FIGS. 1 to 6. FIG. 1 is an isometric view of a medical illumination device 10 that is constructed and operable in accordance with a preferred embodiment of the invention. FIG. 2 is a plan view of medical illumination device 10 of FIG. 1. FIG. 3 is a plan view of medical illumination device 10 of FIG. 1 after being extended. FIG. 4 is view of the anterior end 12 of medical illumination device 10 of FIG. 1. FIG. 5 is a cross-sectional view through line A-A of FIG. 2. FIG. 6 is a cross-sectional view through line B-B of FIG. 3. Medical illumination device 10 is configured for illuminating a desired region of a patient, for example, but not limited to, a body cavity such as the mouth. Medical illumination device 10 is for use by a medical practitioner, for example, but not limited to a dental surgeon or technician. Medical illumination device 10 is for use with a variety of different sized powered or non-powered medical instruments, for example, but not limited to, a dental rotary instrument and a dental mirror. Medical illumination device 10 is a compact and cordless lighting device. Medical illumination device 10 includes a housing 14. Housing 14 includes a light source housing 16 and a power source housing 18. Light source housing 16 is mechanically connected, typically using a screw, to power source housing 18. Light source housing 16 is removable from power source housing 18 for maintenance or replacement of light source housing 16. Light source housing 16 is typically a clear hollow cylindrical container, which is made from a material that withstands sterilization in an autoclave. Light source housing 16 is typically formed from heat resistant glass. Medical illumination device 10 includes approximately five or more light sources 20 disposed within the cavity of light source housing 16. Light sources 20 are typically light emitting diodes (LED's). A vacuum is formed in the cavity of light source housing 16 to prevent condensation build up on the inner surface of light source housing 16 during use of medical illumination device 10. Medical illumination device 10 includes a power source 22 disposed in power source housing 18. Power source 22 provides the power to operate light sources 20. Power source 22 is recharged in an external charger (not shown). Power source 22 is removed from power source housing 18 before medical illumination device 10 is sterilized. Power source housing 18 is described in more detail with reference to FIG. 8.

Medical illumination device 10 includes a reflecting element 24. Reflecting element 24 is disposed around light source housing 16 and is mechanically connected to housing 14 via a connecting member 32. Reflecting element 24 is formed as an incomplete cylinder, which circumscribes light source housing 16 for 270 degrees. Reflecting element 24 includes a substantially cylindrical reflecting surface 26 on the inner surface of reflecting element 24. Reflecting surface 26 is described as “substantially cylindrical” in that reflecting surface 26 only forms the majority of a cylinder and not a complete cylinder. Reflecting surface 26 is typically formed from a reflecting material, which withstands sterilization in an autoclave, for example, but not limited to, stainless steel. Reflecting surface 26 typically has a thickness of 0.5 mm. Reflecting surface 26 is configured for concentrating light produced by light sources 20 thereby maximizing the output of light sources 20. Reflecting surface 26 is also configured for directing light emitted by light sources 20 on to the desired region of the patient. There is a gap 34 of approximately 0.5 mm between reflecting surface 26 and the outer surface of light source housing 16 in order to allow for efficient heat dissipation from light sources 20. Reflecting element 24 has an outer surface 28 which is formed from an insulating material which withstands sterilization in an autoclave. Outer surface 28 is typically formed from a heat resistant plastic. Outer surface 28 typically has a thickness of 0.5 mm. Outer surface 28 reduces heat transfer from light sources 20 to the patient. Additionally, as reflecting surface 26 reflects the light produced by light sources 20, reflecting surface 26 reduces heating of reflecting element 24. Reflecting element 24 has rounded edges 30 to prevent patient tissue damage. Rounded edges 30 are typically formed from plastic, which withstands sterilization by chemical or autoclave devices.

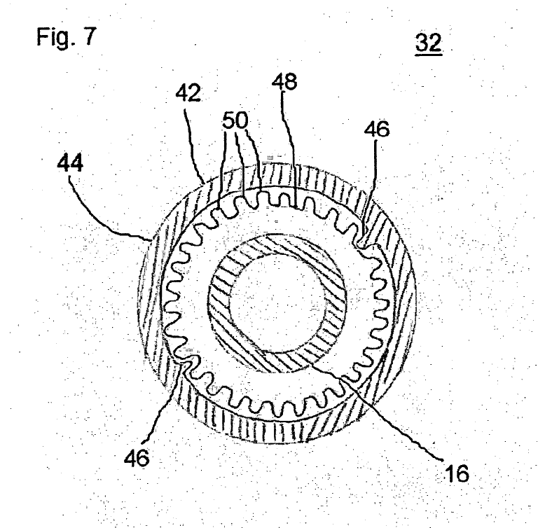

Connecting member 32 mechanically connects reflecting element 24 and housing 14 such that, reflecting element 24 is rotatable, in order to selectively direct light emitted by light sources 20 on to the desired region of the patient. Reflecting element 24 is continuously rotatable in both directions around light source housing 16. Connecting member 32 includes a grip surface 42, which allows easy adjustment of the position of reflecting element 24. Connecting member 32 also includes a locking mechanism 36 configured for reversibly locking a position of reflecting element 24. Locking prevents rotation of reflecting element 24 during use of medical illumination device 10. Locking mechanism 36 is described in more detail with reference to FIG. 7.

Reflecting element 24 serves additional functions, including blocking direct vision by the medical practitioner of light sources 20 as well as acting as a retractor of soft tissue.

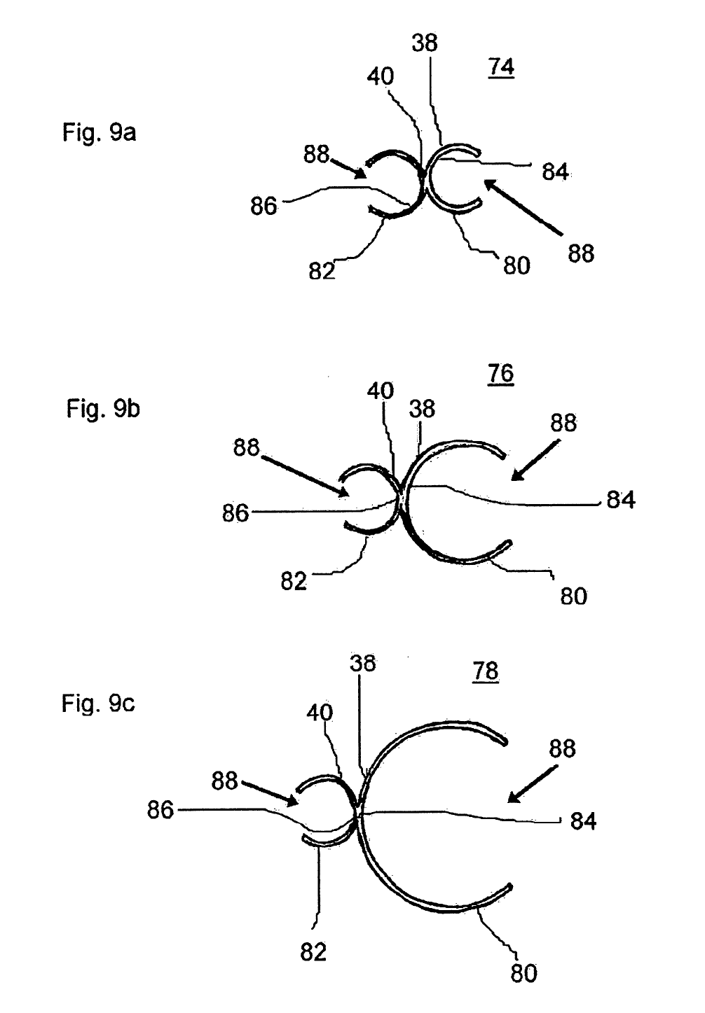

Medical illumination device 10 has an attachment configuration 38 including a set of interchangeable attachment elements 40 configured for reversibly attaching power source housing 18 to a variety of different sized medical instruments. Interchangeable attachment elements 40 are configured such that, medical illumination device 10 is rotatable around the medical instrument, as required, such that medical illumination device 10 can be positioned in any required orientation. Attachment configuration 38 and interchangeable attachment elements 40 are described in more detail with reference to FIGS. 9a to 9c.

All the elements of medical illumination device 10, including housing 14, interchangeable attachment elements 40, connecting member 32 and reflecting element 24 are made from materials which withstand sterilization by a medical sterilization device, for example, but not limited to, chemical and/or heat sterilization treatment in an autoclave at a temperature of 135 degrees Centigrade or more.

Medical illumination device 10 is configured as a compact device so as not to obstruct the work of the medical practitioner. Medical illumination device 10 has a length of approximately 28 mm and a diameter of 4 mm. Reflecting element 24 has a length of approximately 10 mm and an outer diameter of 4 mm and an inner diameter of 3 mm. Connecting member 32 has an outer diameter of 4 mm and a length of 6 mm. Power source housing 18 has an outer diameter of 4 mm and a total length of 12 mm. Light source housing 16 has an outer diameter of 2 mm and an inner diameter of 1 mm. Light source housing 16 is distanced by 2 mm from the open end of reflecting element 24 so that patient tissue should not come into contact with light source housing 16, which may be hot.

Reference is now made to FIGS. 5 to 7. FIG. 7 is a cross-sectional view through line C-C of FIG. 2. Connecting member 32 includes an outer hollow cylinder 44. Outer cylinder 44 is mechanically connected to outer surface 28 of reflecting element 24. Typically, outer surface 28 and outer cylinder 44 are formed as a unitary element. The outer surface of outer cylinder 44 includes grip surface 42. The inner surface of outer cylinder 44 includes two ridges 46 disposed thereon (FIG. 7). Connecting member 32 includes an inner hollow cylinder 48. Inner hollow cylinder 48 is disposed within the hollow of outer cylinder 44. The outer surface of inner hollow cylinder 48 includes a plurality of ridges 50 thereon (FIG. 7). Ridges 50 are arranged in a similar manner to teeth on a gear wheel. The inner surface of inner hollow cylinder 48 surrounds one end of light source housing 16. Ridges 46 mesh with gaps between ridges 50 thereby preventing rotation motion of outer cylinder 44 and reflecting element 24. The end of the inner surface of outer cylinder 44 closest to power source housing 18 includes a radial projection 52 disposed thereon. Similarly, the end of the outer surface of inner hollow cylinder 48 farthest from power source housing 18 includes a radial projection 56 disposed thereon. A compression spring 54 is disposed between radial projection 52 and radial projection 56. Compression spring 54 is configured for restoring the position of outer cylinder 44 against power source housing 18, as will be described below. Ridges 46, ridges 50, radial projection 52, radial projection 56 and compression spring 54 form locking mechanism 36.

In operation, the rotational position of reflecting element 24 is adjusted by pulling outer cylinder 44 away from power source housing 18, using grip surface 42. As outer cylinder 44 is pulled away from power source housing 18, ridges 46 are removed from the gaps between ridges 50, thereby freeing rotation movement of outer cylinder 44 and reflecting element 24. The rotational position of reflecting element 24 is then adjustable. After the rotational position of reflecting element 24 has been adjusted, the user lets go of grip surface 42 and compression spring 54 pushes outer cylinder 44 back toward power source housing 18.

Reference is now made to FIG. 8, which is an enlarged cross-sectional view of power source housing 18 of medical illumination device 10 of FIG. 1 through line A-A of FIG. 2. Power source housing 18 is formed from stainless steel cylindrical container 60 with an inner plastic lining. Power source housing 18 includes a plastic screw cover 58, which screws into container 60. Screw cover 58 also includes a push-button on-off switch 62, configured for turning light sources 20 on and off. Container 60 includes an electrical contact 64 configured for making contact with one terminal of power source 22. Screw cover 58 includes an electrical contact 66 for making contact with another terminal of power source 22. Electrical contact 64 is electrically connected to one terminal of light sources 20 (FIGS. 5 and 6) via a wire 68. Electrical contact 66 is electrically connected to another terminal of light sources 20 via switch 62 using a wire 70. Light sources 20 are wired in parallel. A screw thread 72 is disposed on container 60 and screw cover 58 for mechanically connecting container 60 and screw cover 58. Screw thread 72 is formed from an electrically conducting material in order to electrically connect light sources 20 and switch 62 via wire 70. Screw cover 58 includes a silicon-lined region configured for providing a hermetic seal for container 60 when screw cover 58 is screwed into container 60.

FIG. 9a is a side view of an interchangeable attachment element 74 for use with medical illumination device 10 of FIG. 1. FIG. 9b is a side view of an interchangeable attachment element 76 for use with medical illumination device 10 of FIG. 1. FIG. 9c is a side view of an interchangeable attachment element 78 for use with medical illumination device 10 of FIG. 1. Interchangeable attachment element 74, interchangeable attachment element 76 and interchangeable attachment element 78 are examples of interchangeable attachment elements 40 of attachment configuration 38. Attachment configuration 38 includes a set of eight double-ring interchangeable attachment elements 40. Each interchangeable attachment element 40 includes a uniquely sized clamping member 80 and another clamping member 82. Clamping member 80 and clamping member 82 are permanently mechanically connected, typically by welding. The term “permanently mechanically connected” is defined herein as, a mechanical connection which is not designed for convenient connection and disconnection. Clamping member 80 is configured for being reversibly attached to a suitably sized medical instrument. Clamping member 82 is configured for being reversibly attached to power source housing 18 (FIG. 1) of medical illumination device 10. Clamping member 80 includes a restoring element 84 for restoring a shape of clamping member 80 after expansion. Similarly, clamping member 82 includes a restoring element 86 for restoring a shape of clamping member 82 after expansion. Clamping member 80 and clamping member 82 are each typically formed from a thin piece of springy stainless steel having a thickness of approximately 0.5 mm, a width of 10 mm and a length according to the diameter of the medical instrument and medical illumination device 10, respectively. Each piece of stainless steel is bent to form an open ring with an opening 88. Opening 88 typically has the size of a 90-degree arc of the ring, in other words one-quarter of the ring, if the ring was whole. The ring of clamping member 82 has an inner diameter of 4 mm. The ring of clamping member 80 has an inner diameter of either 4 mm, 6 mm, 10 mm, 12 mm, 14 mm, 16 mm, 18 mm or 20 mm. Each interchangeable attachment element 40 has a different inner diameter for its clamping member 80. It will be appreciated by those ordinarily skilled in the art that clamping member 80 can have other diameters. Each stainless steel ring is then joined together, typically by welding. As the stainless steel is springy, restoring element 84 and restoring element 86 are integrally formed with clamping member 80 and clamping member 82, respectively. However, it will be appreciated by those ordinarily skilled in the art that clamping member 80 and clamping member 82 can be configured whereby restoring element 84 and restoring element 86 are separate elements which are mechanically connected to the rest of clamping member 80 and clamping member 82, respectively. The inner surfaces of clamping member 80 and clamping member 82 are lined with silicon in order to prevent scratching of the medical instruments and medical illumination device 10, respectively. Clamping members 80 and clamping members 82 are configured so that it is easier to remove interchangeable attachment elements 40 from the medical instruments than it is to remove interchangeable attachment elements 40 from medical illumination device 10.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A medical illumination device for illuminating a desired region of a patient, the device being for use by a medical practitioner with a medical instrument, the device comprising:
(a) a housing;
(b) at least one light source disposed in said housing;
(c) an attachment configuration configured for reversibly attaching said housing to the medical instrument;
(d) a reflecting element configured for directing light emitted by said at least one light source on to the desired region of the patient; and
(e) a connecting member mechanically connecting said reflecting element and said housing such that, said reflecting element is rotatable in order to selectively direct light emitted by said at least one light source on to the desired region of the patient.

2. The device of claim 1, wherein, when said housing and said reflecting element are mechanically connected, said housing and said reflecting element fit into a cylinder having a diameter of 8 mm and a length of 5 cm.

3. The device of claim 1, wherein at least one of said reflecting element and said connecting member are configured for blocking direct vision by the medical practitioner of said at least one light source.

4. The device of claim 1, wherein said connecting member includes a locking mechanism configured for reversibly locking a position of said reflecting element.

5. The device of claim 1, wherein said reflecting element is configured as a curved reflecting surface.

6. The device of claim 5, wherein said reflecting element includes a substantially cylindrical reflecting surface, said substantially cylindrical reflecting surface being disposed around said at least one light source.

7. The device of claim 1, wherein said reflecting element is configured to concentrate the light produced by said at least one light source.

8. The device of claim 1, wherein said housing, said attachment configuration and said reflecting element are configured to withstand sterilization.

9. The device of claim 1, wherein said attachment configuration includes a first clamping member and a second clamping member, said first clamping member being permanently mechanically connected to said second clamping member, said first clamping member including a restoring element for restoring a shape of said first clamping member after expansion, said second clamping member including a restoring element for restoring a shape of said second clamping member after expansion, said first clamping member being configured for being reversibly attached to the medical instrument, said second clamping member being configured for being reversibly attached to said housing.

10. The device of claim 1, wherein said attachment configuration includes a set of interchangeable attachment elements for reversibly attaching said housing to a plurality of different size medical instruments, each of said interchangeable attachment elements having a uniquely sized clamping member configured for being reversibly attached to one of said medical instruments.

11. The device of claim 10, wherein:
(a) said uniquely sized clamping member includes a restoring element for restoring a shape of said uniquely sized clamping member after expansion;
(b) each of said interchangeable attachment elements also includes a second clamping member including a restoring element for restoring a shape of said second clamping member after expansion; and
(c) said second clamping member being configured for being reversibly attached to said housing.

12. A self-powered medical illumination device for illuminating a desired region of a patient, the device being for use by a medical practitioner with a medical instrument, the device comprising:
(a) a housing;
(b) at least one light source disposed in said housing;
(c) a power source disposed in said housing, said power source configured for powering said at least one light source;
(d) an attachment configuration configured for reversibly attaching said housing to the medical instrument; and
(e) a reflecting element configured for directing light emitted by said at least one light source on to the desired region of the patient.

13. The device of claim 12, wherein said reflecting element is configured as a curved reflecting surface.

14. The device of claim 13, wherein said reflecting element includes a substantially cylindrical reflecting surface, said substantially cylindrical reflecting surface being disposed around said at least one light source.

15. The device of claim 12, further comprising a connecting member mechanically connecting said reflecting element and said housing such that, said reflecting element is rotatable in order to selectively direct light emitted by said at least one light source on to the desired region of the patient.

16. The device of claim 12, wherein said housing, said attachment configuration and said reflecting element are configured to withstand sterilization.

17. A medical illumination device for use by a medical practitioner with a medical instrument, the device comprising:
(a) a housing;
(b) at least one light source disposed in said housing; and
(c) an attachment configuration configured for reversibly attaching said housing to the medical instrument, said attachment configuration including a first clamping member and a second clamping member, said first clamping member being permanently mechanically connected to said second clamping member, said first clamping member including a restoring element for restoring a shape of said first clamping member after expansion, said second clamping member including a restoring element for restoring a shape of said second clamping member after expansion, said first clamping member being configured for being reversibly attached to the medical instrument, said second clamping member being configured for being reversibly attached to said housing.

18. The device of claim 17, further comprising a power source disposed in said housing.

19. A medical illumination device for use by a medical practitioner with a plurality of different size medical instruments, the device comprising:
(a) a housing;
(b) at least one light source disposed in said housing; and
(c) an attachment configuration including a set of interchangeable attachment elements for reversibly attaching said housing to the different size medical instruments, each of said interchangeable attachment elements having a uniquely sized clamping member configured for being reversibly attached to one of the medical instruments.

20. The device of claim 19, further comprising a power source disposed in said housing.

21. The device of claim 19, wherein:
(a) said uniquely sized clamping member includes a restoring element for restoring a shape of said uniquely sized clamping member after expansion;
(b) each of said interchangeable attachment elements also includes a second clamping member including a restoring element for restoring a shape of said second clamping member after expansion; and
(c) said second clamping member being configured for being reversibly attached to said housing.
